(19) United States
(12) Patent Application Publication
(10) Pub. No.: US 2017/0171176 A1
(43) Pub. Date: Jun. 15, 2017

(54) MAINTENANCE CREDENTIAL PERMITTING PERFORMANCE OF JUST MAINTENANCE-RELATED ACTIONS WHEN COMPUTING DEVICE REQUIRES REPAIR AND/OR MAINTENANCE

(71) Applicant: Lenovo Enterprise Solutions (Singapore) PTE. LTD., New Tech Park (SG)

(72) Inventors: Srihari Venkata Angaluri, Raleigh, NC (US); Gary David Cudak, Wake Forest, NC (US); Ajay Dholakia, Morrisville, NC (US); Chulho Kim, Poughkeepsie, NY (US); James Steven Worley, Raleigh, NC (US)

(21) Appl. No.: 14/966,839

(22) Filed: Dec. 11, 2015

(51) Int. Cl. H04L 29/06; G06F 11/07

(52) U.S. Cl. CPC H04L 63/08; G06F 11/0709; G06F 11/0751; G06F 11/0793; H04L 63/102

(57) ABSTRACT

A set of maintenance-related actions for a computing device is determined. The actions are performed to diagnose, repair, and/or maintain the computing device. The actions can be determined by automatically determining the actions based on diagnostic and/or predictive data regarding the computing device, and/or by permitting an administrator to specify the actions. A maintenance credential for the computing device, such as a digital key, is created, and the set of actions is associated with the maintenance credential. Access to the computing device via the maintenance credential results in just the set of actions being performable at the computing device. The maintenance action can be securely provided to maintenance personnel when the computing device requires repair and/or maintenance, so that the device can be diagnosed, repaired and/or maintained without compromising security of the computing device.

### BACKGROUND

Information technology (IT) infrastructure for entities like enterprises can include a large number of computing devices, such as servers, which may be installed in a data center. Such computing devices commonly are mission critical, meaning that they perform functionality and store data that may have to constant availability. While such computing devices are usually constructed from high quality components to decrease the likelihood of failure, at times computing devices can and indeed do fail.

### SUMMARY

An example method includes accessing a computing device, by personnel via a maintenance credential, to one or more of diagnose, repair, and maintain the computing device. Access to the computing device via the maintenance credential results in just a set of maintenance-related actions associated with the maintenance credential being performable at the computing device. The method includes, in response to the computing device being accessed by the personnel via the maintenance credential, permitting the personnel to perform just any of a set of maintenance-related actions for the computing device, to the one or more of diagnose, repair, and maintain the computing device.

An example non-transitory computer-readable data storage medium stores computer-executable code executable by a computing device to perform a method. The method includes dynamically determining a set of maintenance-related actions for a target computing device. The maintenance-related actions are performable to one or more of diagnose, repair, and maintain the target computing device. The set of maintenance-related actions are dynamically determined by one or more of: automatically determining the set of maintenance-related actions based on data regarding the target computing device, and permitting an administrator to specify the set of maintenance-related actions. The method includes creating a maintenance credential for the computing device, and associating the set of maintenance-related actions with the maintenance credential.

An example system includes a processor, a storage device storing computer-executable code that the processor executes to perform the following. A set of maintenance-related actions for a target computing device is determined. The maintenance-related actions are performable to one or more of diagnose, repair, and maintain the target computing device. The set of maintenance-related actions is determined by one or more of: automatically determining the set of maintenance-related actions based on data regarding the target computing device, and permitting an administrator to specify the set of maintenance-related actions. A maintenance credential for the target computing device is created. The set of maintenance-related actions is associated with the maintenance credential. Access to the target computing device via the maintenance credential results in just the set of maintenance-related actions being performable at the target computing device. The maintenance credential is provided to maintenance personnel when the target computing device requires one or more of diagnosing, repair, and maintenance.

### BRIEF DESCRIPTION OF THE DRAWINGS

FIG. 1 is a diagram of an example architecture in which a server can be maintained or repaired at a repair facility without compromising the security of the server.

FIG. 2 is a flowchart of an example method for maintaining or repairing a server at a repair facility without compromising the security of the server.

FIG. 3 is a flowchart of an example method for generating a set of maintenance-related actions that can be performed on a server to maintain or repair the server without compromising its security.

FIG. 4 is a block diagram of an example server.

### DETAILED DESCRIPTION

As noted in the background section, computing devices like servers can be installed in data centers. When a computing device fails, traditionally the computing device may have been repaired on-site, by personnel employed by or at least affiliated with the enterprise or other entity owning or at least using the computing device. Such on-site service provided a modicum of security, insofar as the maintenance or repair of a computing device could easily be monitored to ensure, for instance, that confidential data did not leave the premises of the data center.

However, more recently, it is not uncommon for a computing device to be removed at some time thereafter and sent to a service facility for repair or maintenance, for at least cost reasons. The maintenance personnel at the service facility are not usually employed by the enterprise or other entity owning or at least using the computing device. Because of this likely lack of an employer-employee relationship, and because of the computing device being located away from the premises of the data center, security of the computing device can more likely be compromised.

In general, repair or maintenance of a computing device requires access to the computing device. That is, the maintenance personnel typically have to be able to log into the computing device in order to assess the reason for failure and/or to perform the needed repair or maintenance. However, such access can mean that the maintenance personnel have access to confidential data stored on the computing device, and that the maintenance personnel has the ability to install computer-executable code, such as rogue code, on the computing device. Security of the computing device at the off-site repair or maintenance facility thus cannot be guaranteed.

Disclosed herein are techniques that mitigate the potential for the security of a computing device to be compromised, particularly when the device is sent off-site for repair or maintenance. A set of maintenance-related actions for the computing device is determined. These actions are performed to diagnose, repair, and/or maintain the computing device. The actions can be determined automatically, based on diagnostic and/or predictive data regarding the device, and/or by permitting an administrator to specify them. A maintenance credential, such as a digital key, is created for the computing device, and the set of actions is associated with this credential.

The maintenance personnel can thus be provided with the maintenance credential. When accessing the computing device using the maintenance credential, the maintenance personnel can perform just the set of maintenance-related actions. The maintenance-related actions may not permit the installation of computer-executable code, such as rogue code, on the computing device, and may not permit the access of any data, such as confidential information, stored on the computing device. Therefore, the techniques disclosed herein permit the computing device to be repaired and/or maintained without compromising the computing device's security.

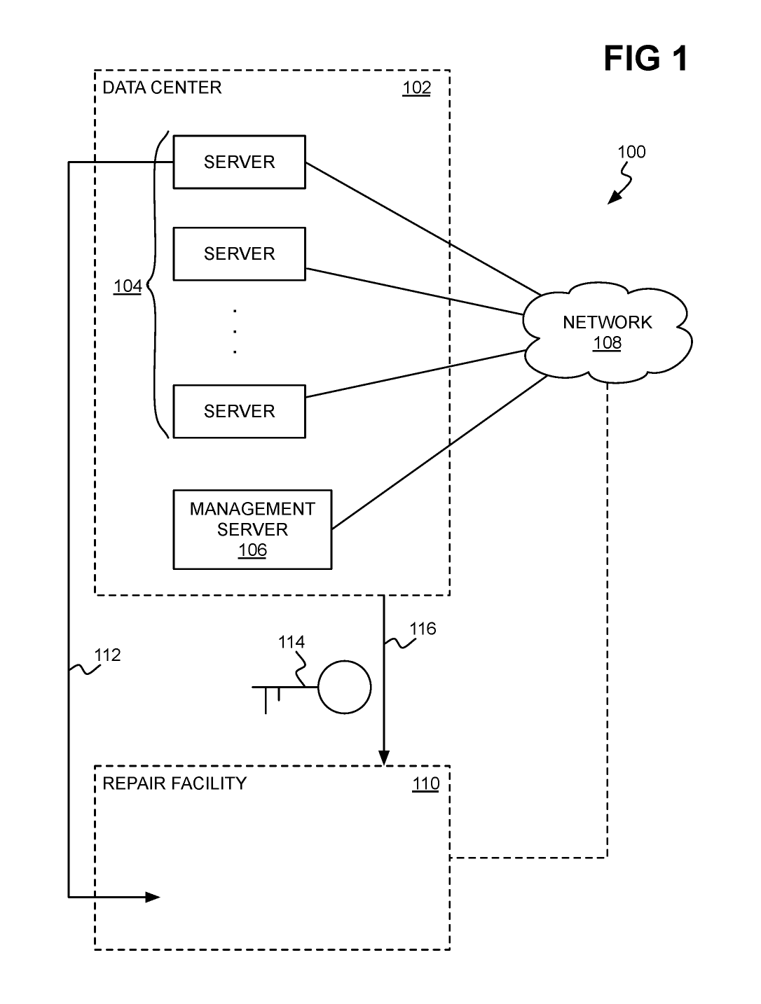

FIG. 1 shows an example architecture 100 in relation with which the techniques disclosed herein can be implemented. There is a data center 102, such as an enterprise data center, including a number of server computing devices 104, which can also be referred to as servers. A management server computing device, or server, 106 that is used to manage the servers 104 can also be located at the data center 102, or the management server 106 may be located elsewhere. The servers 104 and 106 are communicatively connected to a network 108. The network 108 may be or include the Internet, intranets, extranets, wide-area networks (WANs), local-area networks (LANs), wired networks, wireless networks, cellular or telephony networks, as well as other types of networks.

Located apart from the data center 102 is a repair facility 110. The repair facility 110 may be maintained by a different company than the data center 102. For example, where the servers 104 are owned by or operated on behalf of an enterprise, the repair facility 110 may be owned by or operated by a different company. The repair facility 110 also has a communicative connection to the network 108.

When a server 104 fails, it may fail over to another spare or backup server 104, and be taken offline within the data center 102. At some point in time thereafter, the server 104 may be physically sent to the repair facility 110 for maintenance or repair, as indicated by the arrow 112. Personnel at the repair facility 110 therefore diagnose and hopefully repair the server 104 in question once the server 104 has arrived at the repair facility.

A credential 114 is securely provided to the repair facility 110, as indicated by the arrow 116. The credential 114 may be in the form of a username and password combination, or a digital key. In the latter case, for instance, the digital key may be the public key of a public key-private key pair, where the management server 106 may maintain the private key. The personnel at the repair facility 110 uses the credential 114 to gain access to the server 104 that has been sent for repair. In the case of a digital key, for instance, the server 104 may transmit the public key that the personnel have provided to the management server 106, with the management server 106 confirming that the public key matches its private key to approve access to the server 104.

The credential 114 is associated with a set of maintenance actions that the personnel can perform on the server 104 undergoing repair or maintenance at the repair facility 110. Actions other than these maintenance actions are not permitted to be performed. In general, the maintenance actions are those sufficient to permit the personnel to diagnose and properly maintain or repair the server 104, without compromising the security of the server 104.

Examples of maintenance actions that may be specified include those that permit the personnel at the repair facility 110 to test various hardware components and assemblies of the server 104, such as storage devices, memory, processors, hardware interfaces like input/output (I/O), storage device, and memory interfaces, and so on. Examples of actions that may not be included as part of the maintenance actions may be accessing data stored on the storage devices, and installation of computer-executable code on the server 104. Therefore, once the server 104 has been successfully maintained or repaired, it can be returned to the data center 102 for reconnection within the data center 102. The enterprise owning the server 104 or the enterprise on whose behalf the server 104 is being operated can thus be assured to a great if not complete degree that the security of the server 104 has not been compromised.

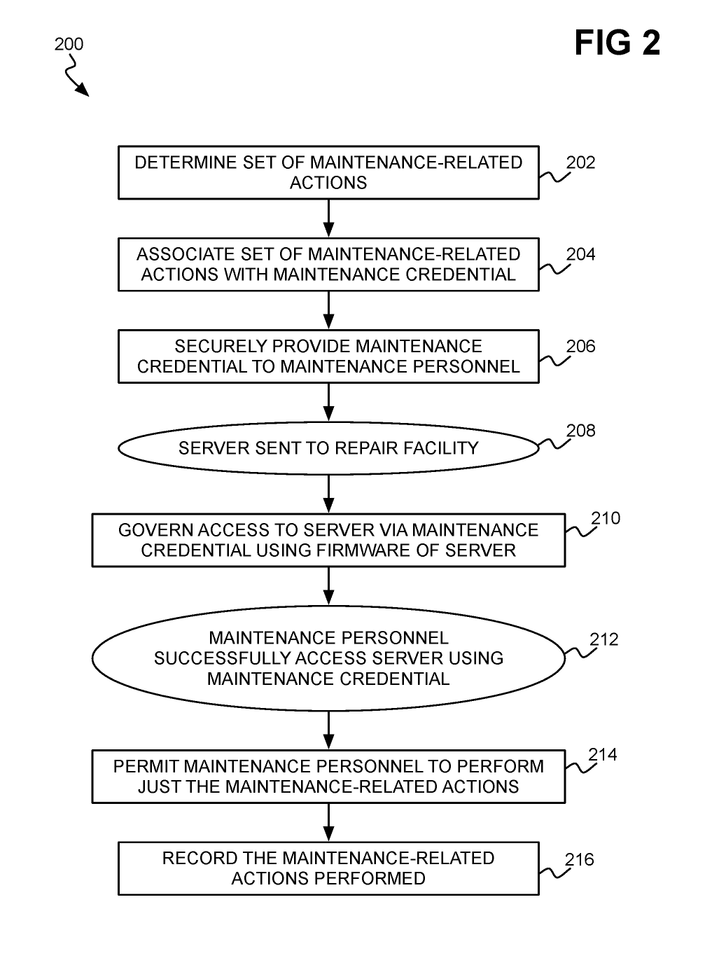

FIG. 2 shows an example method 200 for maintaining or repairing a server 104 at the repair facility 110 without compromising the security of the server 104. A set of maintenance-related actions that can be performed by maintenance or repair personnel at the facility 110 on the server 104 is determined (202). Different manners by which the set of maintenance-related actions can be determined are described later in the detailed description. In general, the actions are performable to diagnose, repair, and/or maintain the server 104.

The set of maintenance-related actions can be limited in scope so that the security of the server 104 cannot be compromised when the actions are performed to maintain or repair the server 104. As noted above, for instance, the set of maintenance-related actions may not permit access to confidential information stored on storage devices of the server 104. The set of maintenance-related actions may not permit the installation of computer-executable code to be installed on the server 104. This means that rogue computer-executable code cannot be installed on the server 104.

The set of maintenance-related actions is associated with a maintenance credential 114 (204). As noted above, the maintenance credential 114 may be a digital key, or may be a username and password combination. The maintenance credential 114 is then securely provided to maintenance personnel at the repair facility 110 (206), and the server 104 at some point in time sent to the repair facility 110 (208). The credential 114 may be provided by text message, email, over the phone, and so on. The transmission of the credential 114 can be considered secure in that it is not sent with the server 104 itself to the repair facility 110. Therefore, if the server 104 is lost en route to the facility 110, the credential 114 cannot be obtained from within the package encasing the server 104 during delivery.

In one implementation, access to the server 104 via the maintenance credential 114 is governed using firmware of the server 104 (210). The firmware may be a basic input/output system (BIOS), a unified extensible firmware interface (UEFI), and so on. The firmware in this respect controls and monitors the performance of the maintenance-related actions once the server 104 is accessed using the maintenance credential 114. Therefore, security of the server 104 can be additionally ensured because interaction with the server 104 occurs through the firmware.

The maintenance personnel thus successfully access the server 104 using the maintenance credential 114 (212). At that time, the maintenance personnel can perform just the maintenance-related actions in diagnosing, maintaining, and repairing the server 104 (214). As noted above, other actions cannot be performed by the maintenance personnel on the server 104. Further, in one implementation, as the maintenance personnel perform the maintenance-related actions, which actions are performed and in what order are recorded in a log (216), which can subsequently be provided back to the enterprise of the data center 102. In this way, security is also heightened, because the enterprise is able to learn exactly what the actions the personnel performed on the server 104 once the server 104 has been returned to the data center 102.

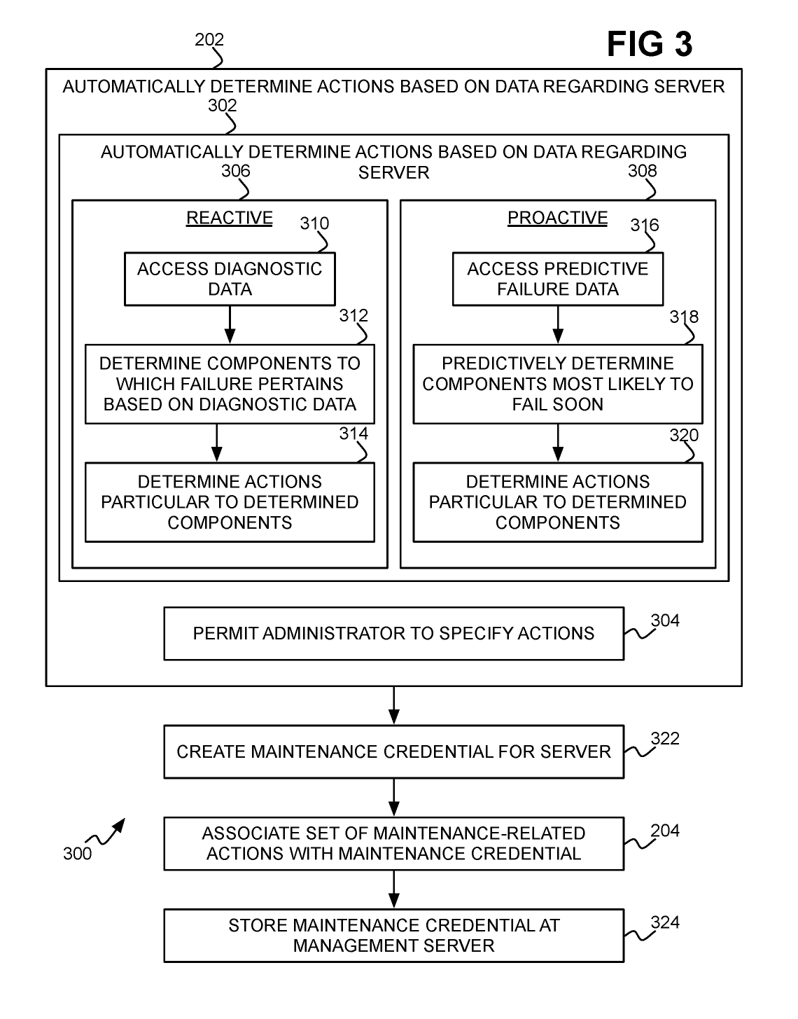

FIG. 3 shows an example method 300 for determining a set of maintenance-related actions for a server 104 (300). The method 300 can be implemented as computer-executable code stored on a non-transitory computer-readable data storage medium and executed by a processor of a computing device, such as a server. A non-transitory medium as used herein includes memory, such as volatile as well as non-volatile random-access memory, and also storage devices like hard disk drives. The server that performs the method 300 may in some cases be the same server 104 that is to undergo maintenance or repair, and may in other case be a different server than the server 104 that is to undergo maintenance or repair.

In the method 300, the set of maintenance-related actions is specifically dynamically determined (202). More specifically still, the actions can be determined in either or both of two ways. First, the set of maintenance-related actions can be performed automatically, such as without user interaction, based on data regarding the server 104 in question (302). Second, the set of maintenance-related actions can be determined by permitting an administrator at the data center 102, for instance, to specify the actions (304). When both parts 302 and 304 are performed, the administrator may be permitted to add other maintenance-related actions in part 304, in addition to those that have been automatically determined in part 302, and may be permitted to remove in part 304 one or more of the actions that have been automatically determined in part 302.

Automatically determining the maintenance-related actions based on data regarding the server 104 can include either or both of a reactive approach (306) and a proactive approach (308). In the reaction approach of part 306, when a failure-related event occurs at the server 104, diagnostic data is typically generated. Therefore, this diagnostic data regarding the failure-related event at the server 104 is accessed (310), and the components of the server to which the failure-related event pertains are determined based on this diagnostic data (312). Appropriate maintenance-related actions particular to these components that are responsible for, associated with, or at which the failure of the server 104 occurred are then determined (314).

For example, a memory module such as a dual-inline memory module (DIMM) of the server 104 may fail. The diagnostic data may indicate, for instance, that the DIMM repeatedly suffered errors for which even the DIMM's built-in error-correcting code (ECC) could not compensate. Therefore, this DIMM is identified, and the maintenance-related actions determined include those, for instance, to test the proper operation of the DIMM. As such, the repair personnel can verify the failure of the DIMM by performing these actions, and further verify the proper operation of a new, replacement DIMM that is substituted for the failed DIMM.

In this way, the maintenance-related actions are tailored to the component or components that caused the failure-related event. Other actions—even other maintenance-related actions—may not be specified, because they are irrelevant to the failure in question. In the above example, for instance, maintenance-related actions related to the networking hardware of the server 104 may not be included within the set of actions that the repair personnel are permitted to perform, because the networking hardware is functioning properly and there is no reason for the personnel to have to perform any actions in relation to this hardware.

In the proactive approach of part 308, a failure-related event has not yet occurred at the server 104. However, when a failure does occur, diagnostic data regarding the event may not be logged, or if logged may not reveal the error. Therefore, before a failure occurs, part 308 is periodically performed at regular intervals. Predictive failure data regarding the server 104 is accessed (316). The predictive failure data can include mean time between failure (MTBF) data for each component of the server 104, for instance, as well as the how long each component has already been in operation. As another example, the predictive failure data can include the current voltage values of a power supply of the server 104, as well as the range of voltage values that the power supply has been manufactured to provide, such as a tolerance range thereof.

Based on this predictive failure data, the components that are most likely to fail soon are predictively determined (318). For example, any component that has been in operation for a length of time approaching its MTBF specification may be determined as a component that is likely to fail soon. As another example, if a power supply is providing voltage at values outside its specified tolerance range, this may mean that the power supply is likely to fail soon.

Appropriate maintenance-related actions particular to the components that have been predictively determined to most likely to fail soon are then determined (320), in a similar manner as has been described above in relation to part 314. Therefore, when the server 104 does fail in the future, and if no diagnostic data regarding the failure-related event is present or if the data does not reveal the cause of the event, the likely cause of the failure may be deemed as one of the components that were predicted as most likely to fail. As such, the maintenance-related actions are proactively determined as particular to and tailored for these components of the server 104.

Once the set of maintenance-related actions have been determined, a maintenance credential 114 is created for the server 104 (322). As noted above, the maintenance credential 114 may be a username and password pair, a digital key, or another type of credential. The set of maintenance-related actions is associated with the maintenance credential 114 (204) as before. The maintenance credential 114 may be stored at the management server 106, or other management device that governs access to the server 104. The personnel at the repair facility 110 thus send the maintenance credential 114, once they securely receive the credential 114, to the management server 104 to gain access to the server 104.

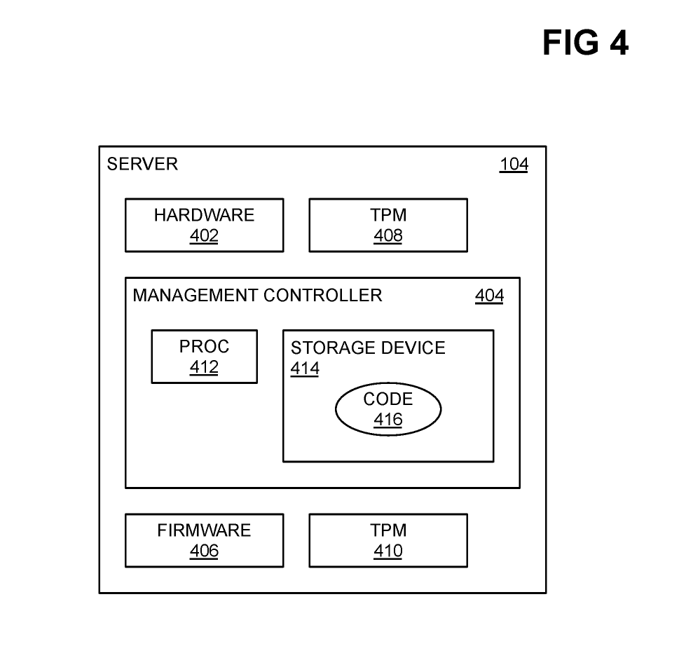

FIG. 4 shows an example server 104. The server 104 includes hardware 402, such as processors, memory, storage devices like hard disk drives, networking hardware and so on. The server 104 can include a management controller 404 and/or firmware 406. The server 400 can include one or two trusted platform modules (TPMs) 408 and 410.

The management controller 404 can also be referred to as a baseboard management controller (BMC) or an integrated management module (IMM). The management controller 404 includes its own processor 412 and its own storage device 414, such as non-volatile memory, which stores computer-executable code 416. The management controller 404 permits management of the server 104 without affecting the performance of the primary hardware 402 running tasks, and permits management of the server 104 even if the primary hardware 402 has failed. The processor 412 can execute the code 416 from the storage device 414 to perform the methods that have been described.

The firmware 406 may be a UEFI, a BIOS, or another type of firmware. The firmware 406 may be used in one implementation to govern access to the server 104 via the maintenance credential 114, as has been described above. The TPMs 408 and 410 are each dedicated processors designed to secure the hardware 402 via integration of cryptography within the server 104. The TPM 408 is associated with an end user credential, and permits access to the server 104 via an end user credential, so that end user-related actions larger in scope than the set of maintenance-related actions can be performed on the server 104.

By comparison, the TPM 410 is particular to a maintenance mode of the server 104 in which the set of maintenance-related actions is performed. As such, the

TPM 410 is associated with the maintenance credential 114 to permit access to the server 104 via the maintenance credential 114 in one implementation. Presence of the second TPM 410 thus provides additional security, because access to the server 104 via the maintenance credential 114 is governed by an entirely different TPM—the TPM 410—than the TPM 408 that normally governs access to the server 104 for day-to-day usage of the server 104.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such and therefore, it is manifestly intended that this invention be limited only by the claims and equivalents thereof.

We claim:

1. A method comprising:
accessing a computing device, by personnel via a maintenance credential, to one or more of diagnose, repair, and maintain the computing device, access to the computing device via the maintenance credential resulting in just a set of maintenance-related actions associated with the maintenance credential being performable at the computing device; and
in response to the computing device being accessed by the personnel via the maintenance credential, permitting the personnel to perform just any of a set of maintenance-related actions for the computing device, to the one or more of diagnose, repair, and maintain the computing device.

2. The method of claim 1, further comprising, in response the computing device being accessed by the personnel via the maintenance credential:
as the personnel perform one or more of the set of maintenance-related actions, recording the maintenance-related actions that the personnel perform.

3. The method of claim 1, further comprising:
determining the set of maintenance-related actions for the computing device;
associating the set of maintenance-related actions with the maintenance credential for the computing device; and
providing the maintenance credential to the personnel when the target computing device requires one or more of diagnosing, repair, and maintenance.

4. The method of claim 3, further comprising:
governing access to the computing device via the maintenance credential via a firmware of the computing device,
wherein the firmware controls and monitors performance of the set of maintenance-related actions responsive to the computing device being accessed via the maintenance credential.

5. The method of claim 3, further comprising one of:
generating the maintenance credential at a time of original manufacture of the computing device;
generating the maintenance credential at an end user location of the computing device.

6. The method of claim 3, wherein the set of maintenance-related actions are limited in scope such that security of the computing device cannot be compromised when the maintenance-related actions are performed.

7. The method of claim 1, wherein the set of maintenance-related actions do not permit access to confidential information stored on the computing device.

8. The method of claim 1, wherein the set of maintenance-related actions do not permit computer-executable code from being installed on the computing device.

9. The method of claim 1, wherein the maintenance credential is one of:
a username and password combination;
a digital key.

10. The method of claim 3, wherein the computing device comprises:
a first trusted platform module (TPM) associated with an end user credential and permitting access to the computing device via the end user credential, access to the computing device via the end user credential resulting in a set of end user-related actions larger in scope than the set of maintenance-related actions being performable at the computing device; and
a second TPM associated with the maintenance credential and permitting access to the computing device via the maintenance credential.

11. A non-transitory computer-readable data storage medium storing computer-executable code executable by a computing device to perform a method comprising:
dynamically determining a set of maintenance-related actions for a target computing device, the maintenance-related actions performable to one or more of diagnose, repair, and maintain the target computing device, by one or more of:
automatically determining the set of maintenance-related actions based on data regarding the target computing device;
permitting an administrator to specify the set of maintenance-related actions;
creating a maintenance credential for the computing device; and
associating the set of maintenance-related actions with the maintenance credential.

12. The non-transitory computer-readable data storage medium of claim 11, further comprising:
storing the maintenance credential at a management computing device that governs access to the target computing device.

13. The non-transitory computer-readable data storage medium of claim 11, wherein dynamically determining the set of maintenance-related actions comprises automatically determining the set of maintenance-related actions based on the data regarding the target computing device.

14. The non-transitory computer-readable data storage medium of claim 13, wherein dynamically determining the set of maintenance-related actions further comprises:
permitting the administrator to edit the set of maintenance-related actions that have been automatically determined based on the data, including adding other maintenance-related actions to the set and removing automatically determined maintenance-related actions from the set.

15. The non-transitory computer-readable data storage medium of claim 13, wherein determining the set of maintenance-related actions based on the diagnostic data comprises, when a failure-related event occurs at the target computing device:
accessing diagnostic data regarding the target computing device;
determining one or more components of the target computing device to which the failure-related event pertains based on the diagnostic data; and
determining the set of maintenance-related actions as maintenance-related actions particular to the components to which the failure-related event pertains.

16. The non-transitory computer-readable data storage medium of claim 13, wherein determining the set of maintenance-related actions based on the diagnostic data comprises, at periodic intervals,
accessing predictive failure data regarding the target computing device;
predictively determining one or more components of the target computing device that are most likely to soon fail, based on the predictive failure data; and
determining the set of maintenance-related actions as maintenance-related actions particular to the components that have been predicted as most likely to soon fail.

17. The non-transitory computer-readable data storage medium of claim 11, wherein dynamically determining the set of maintenance-related actions comprises permitting the administrator to specify the set of maintenance-related actions.

18. The non-transitory computer-readable data storage medium of claim 11, wherein one of:
the computing device and the target computing device are different computing devices;
the computing device and the target computing device are a same computing device.

19. The non-transitory computer-readable data storage medium of claim 11, wherein the maintenance credential is one of:
a username and password combination;
a digital key.

20. A system comprising:
a processor; and
a storage device storing computer-executable code that the processor executes to:
determine a set of maintenance-related actions for a target computing device, the maintenance-related actions performable to one or more of diagnose, repair, and maintain the target computing device, by one or more of:
automatically determining the set of maintenance-related actions based on data regarding the target computing device;
permitting an administrator to specify the set of maintenance-related actions;
create a maintenance credential for the target computing device;
associate the set of maintenance-related actions with the maintenance credential, access to the target computing device via the maintenance credential resulting in just the set of maintenance-related actions being performable at the target computing device; and
provide the maintenance credential to maintenance personnel when the target computing device requires one or more of diagnosing, repair, and maintenance.
